(19) United States
(12) Patent Application Publication
(10) Pub. No.: US 2011/0217009 A1
(43) Pub. Date: Sep. 8, 2011

(54) System for Mounting Optical Modules in an Optical Network

(75) Inventors: Gary Richard Burrell, Wyckoff, NJ (US); Brian O'Donnell, New Windsor, NY (US)

(73) Assignee: Fujitsu Network Communications, Inc., Richardson, TX (US)

(21) Appl. No.: 12/717,628

(22) Filed: Mar. 4, 2010

(51) Int. Cl. G02B 6/36

(52) U.S. Cl. 385/92

(57) ABSTRACT

A system for connecting optical modules in an optical network may comprise a printed circuit board, two cages, and two connectors. The printed circuit board may house electronic circuitry and a plurality of electronic components. The printed circuit board may have a component side and a solder side. The two cages may be mounted back-to-back on opposite sides of the printed circuit board, each cage having a connector end and an I/O end. The two connectors may be mounted back-to-back on opposite sides of the printed circuit board. Each of the two cages may be configured to guide an optical module into the respective connector. Each of the two cages may be mounted at an angle from the respective surface of the printed circuit board such that the respective I/O ends of the two cages are farther apart than the respective connector ends of the two cages.

### BACKGROUND

Telecommunications systems, cable television systems and data communication networks use optical networks to rapidly convey large amounts of information between remote points. In an optical network, information is conveyed in the form of optical signals through optical fibers. Optical fibers comprise thin strands of glass capable of transmitting the signals over long distances with very low loss. Optical networks provide higher capacity and reduced operating costs compared to traditional technologies. Fiber-optic networks may include a system of multiple network components, including switches, routers, converters, modulators, demodulators, etc.

A transceiver may be used to connect a network device (e.g., a switch, a router, a media converter, etc.) to a fiber-optic cable. The transceiver may plug into a port on a motherboard associated with the network device. One standard transceiver is an SFP transceiver (small form-factor pluggable). SFP transceivers are designed to support SONET, Gigabit Ethernet, Fibre Channel, and other communications standards. Some other standard transceivers include SFP+ (higher data transfer rates than SFP), 10 Gigabit Small Form-Factor (XFP), Xenpak, and X2. SFP transceivers, as well as some other types, plug into a port at the edge of a motherboard.

The ports disposed on the motherboard may also include associated cages. For example, an SFP cage is a metal frame that can be mounted to a printed circuit board (PCB) with compliant pins. The SFP cage may be configured to be bezel-mounted to an I/O panel. SFP cages may provide high retention force in the PCB compared to other options, may allow the mounting of SFP transceivers on both sides of a PCB, and are intended to provide grounding for electromagnetic interference.

### SUMMARY

In accordance with a particular embodiment of the present invention, a system for connecting optical modules in an optical network, may comprise a printed circuit board, a first socket, a second socket, a first cage, and a second cage. The printed circuit board may house electronic circuitry and a plurality of electronic components, the printed circuit board having a component side and a solder side. The first socket may be disposed on the component side of the printed circuit board for connecting an optical module to the electronic circuitry housed on the printed circuit board. The first cage may have a first end and a second end. The first end of the first cage may be mounted to the component side of the printed circuit board proximate the first socket, wherein an optical module inserted into the second end of the first cage is retained by the first cage in electronic communication through the first socket to the electronic circuitry housed on the printed circuit board. The first cage may be disposed at an angle to the surface of the printed circuit board so that the first end of the first cage is closer to the surface of the printed circuit board than the second end of the first cage. The second socket may be disposed on the solder side of the printed circuit board for connecting an optical module to the electronic circuitry housed on the printed circuit board, the second socket mounted opposite the first socket. The second cage may have a first end and a second end. The first end of the second cage may be mounted to the solder side of the printed circuit board proximate the second socket, wherein an optical module inserted in the second end of the second cage is retained by the second cage in electronic communication through the first socket to the electronic circuitry. The second cage may be disposed at an angle to the surface of the printed circuit board so that the first end of the second cage is closer to the surface of the printed circuit board than the second end of the second cage.

In accordance with another particular embodiment of the present invention, a system for connecting optical modules in an optical network may comprise a printed circuit board, two cages, and two connectors. The printed circuit board may house electronic circuitry and a plurality of electronic components. The printed circuit board may have a component side and a solder side. The two cages may be mounted back-to-back on opposite sides of the printed circuit board, each cage having a connector end and an I/O end. The two connectors may be mounted back-to-back on opposite sides of the printed circuit board. Each of the two cages may be configured to guide an optical module into the respective connector. Each of the two cages may be mounted at an angle from the respective surface of the printed circuit board such that the respective I/O ends of the two cages are farther apart than the respective connector ends of the two cages.

When optical modules are mounted back-to-back on opposite sides of a printed circuit board (PCB), the optical modules may interfere with one another in operation. For example, latches and/or other components of the optical modules may overlap. Insertion and/or removal of a particular optical module may also require removal of an interfering optical module. In most cases, the freedom to insert and/or remove a particular optical module without being required to remove additional optical modules may provide improved performance and/or down-time in the optical network. The teachings of the present disclosure may provide a system for connecting optical modules that reduces and/or eliminates interference between neighboring optical modules.

It will be understood that the various embodiments of the present invention may include some, all, or none of the enumerated technical advantages. In addition, other technical advantages of the present invention may be readily apparent to one skilled in the art from the figures, description and claims included herein.

### BRIEF DESCRIPTION OF THE DRAWINGS

FIG. 1 illustrates a communication system incorporating teachings of the present disclosure;

FIG. 2 illustrates an isometric view of a plug-in unit for use in an optical communications network in accordance with the teachings of the present disclosure;

FIG. 3 illustrates a top view of the plug-in unit from FIG. 2; and

FIG. 4 illustrates a side view of the plug-in unit from FIG. 2.

### DETAILED DESCRIPTION

Modular communication systems may employ plug-in units (PIU) to provide a variety of functions. PIUs may be allocated in pairs in certain embodiments and may reside in a shelf coupled to a backplane. In certain embodiments of the present disclosure, a system comprising a backplane and one or more PIUs may also include input-output (I/O) panels operable to couple the PIUs to additional components of a communication network.

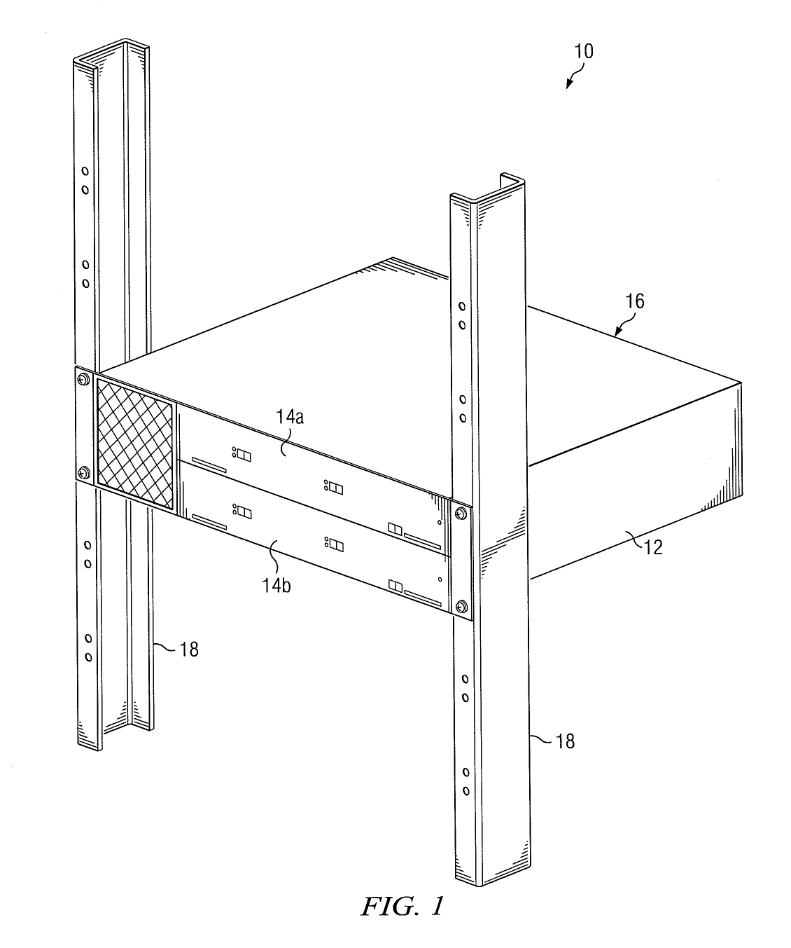

FIG. 1 illustrates a system 10 incorporating teachings of the present disclosure. System 10 may include a case 12, one or more plug-in unites 14 (e.g., 14a and 14b as illustrated in FIG. 1), I/O panel 16, and rack structure 18. System 10 may be used for a variety of applications. In some embodiments, system 10 may be a communications system. PIUs 14a and 14b may provide networking applications, such as telecommunications and/or data routing. PIUs 14a and 14b may comprise physical interfaces on the front side, the back side, or both. The physical interfaces may be configured to connect to other network components plus send and/or receive signals from other network components. Other embodiments may include more than two PIUs 14. In some embodiments, PIUs 14 may be allocated in pairs. PIUs 14 may include a suitable hardware and/or software operable to provide functionality to system 10 (e.g., any memory, processors, and/or additional components).

PIUs 14 may couple to a backplane internal to case 12. A backplane may provide a variety of functions in system 10. For example, a backplane may provide electrical connectivity between components of system 10 and transmit signals between those components. PIUs 14 may include any suitable connector configured to couple PIU 14 to the backplane. The backplane may include one or more midplane connectors. The midplane connectors may receive one or more signals from one or more PIUs 14 and may also receive signals from the backplane. A midplane connector, in such an embodiment, may include a part of the backplane or include a separate component in communication with the backplane. A midplane may provide electrical connection between the backplane and other components of system 10.

I/O panel 16 may provide a variety of functions for system 10. For example, I/O panel 16 may couple to one or more PIUs 14 to send signals and/or receive signals from PIUs 14. I/O panel 16 may communicate with PIUs 14 through a backplane and/or a midplane connector.

In some embodiments, I/O panel 16 may comprise a variety of connectors for transmitting one or more signals to and/or from PIUs 14. For example, I/O panel 16 may include one or more DS1 or DS3 connections. In another example, I/O panel 16 may include Ethernet connections (e.g., 10BASE-T, 100BASE-T, and/or 1000BASE-T). I/O panel 16 may be configured to provide the connections needed by a user for a variety of applications.

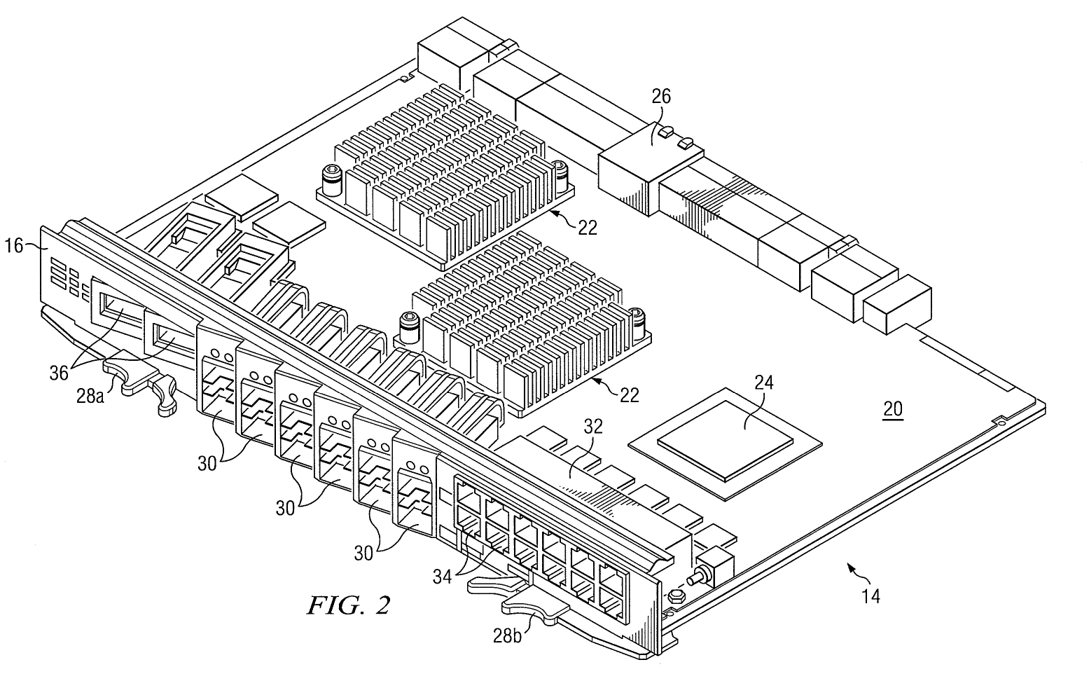

FIG. 2 illustrates an isometric view of a plug-in unit 14 for use in an communications network in accordance with the teachings of the present disclosure. PIU 14 may include an I/O panel 16, a motherboard 20, various electronic components 22 and 24, a backplane connector 26, and physical retainers 28. In some embodiments, PIU 14 may be configured for use in an optical communications network. Motherboard 16 may include a printed circuit board (PCB) and may provide connections for may electronic and/or electrical components of PIU 14, including connectors configured to interface with other components of system 10. For example, one or more processors, memory components and/or other components may plug into sockets on motherboard 16.

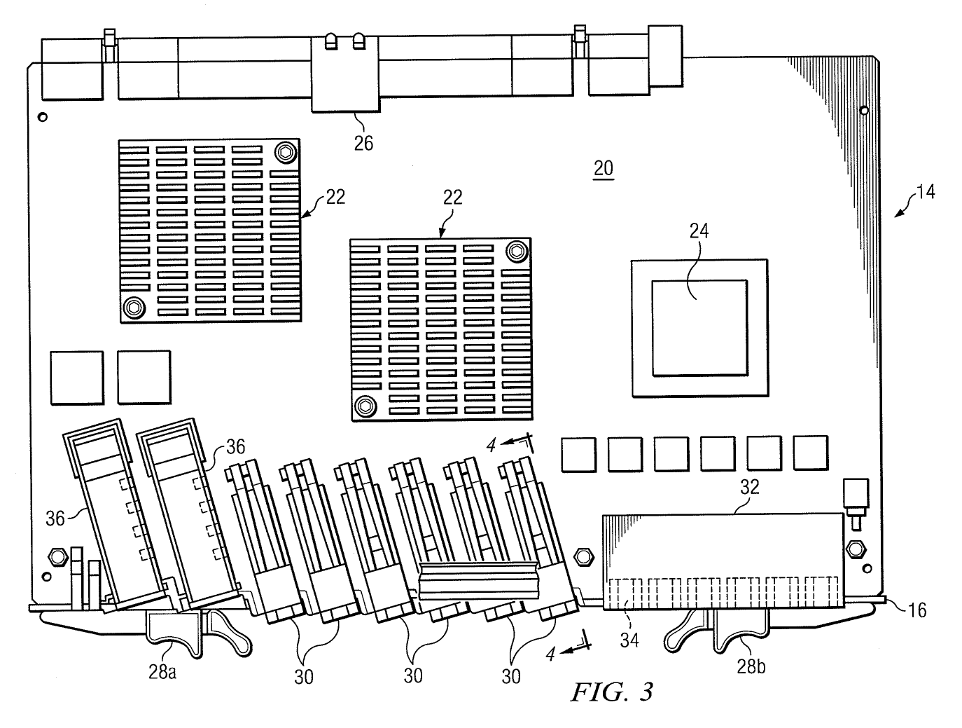

FIG. 3 illustrates a top view of plug-in unit 14. In FIGS. 2 and 3, components 22 and 24 may include processors, memory components, and/or other components. Components 22 are shown with mounted heat sinks and fins and component 24 is shown without a heat sink. Although FIG. 2 only shows one side of motherboard 20, there may be components attached to both sides of motherboard 20. In some embodiments, motherboard 20 may include electrical circuitry connecting the associated components. The circuitry may be disposed on either or both sides of motherboard 20. One having ordinary skill in the art may refer to the “component side” of a motherboard and the “solder side” of a motherboard. Although the nomenclature suggests that only one side of the motherboard includes components, motherboard 20 may include the majority of its components 22 and 24 on the component side (as shown in FIG. 2) and additional components on the solder side.

Backplane connector 26 may be configured to connect PIU 14 to a backplane associated with system 10. Backplane connector 26 may include any combination of pins, sockets, electrical connectors, and/or physical connectors configured to allow PIU 14 to communicate with other components of system 10 and/or to receive power from system 10. Backplane connector 26 may conform to any applicable standard (e.g., SGPIO, SAF-TE, etc.).

Physical retainers 28 may include any physical features, devices, and/or components of PIU 14 configured to retain PIU 14 in rack structure 18. In some embodiments, physical retainers 28 may include bolts and/or clips depending on the configuration of rack structure 18 (e.g., EIA-310-D, CEA-310-E, IEC 60297, and/or DIN 41494).

I/O panel 16 may include any number of connectors configured to provide connectivity between PIU 14 and other components of system 10. For example, as shown in FIG. 2, I/O panel 16 may include fiber optic cable ports 30, twisted pair cable connector 32, and additional communications ports 36. The ports disposed on the motherboard may also include associated cages. For example, a cage is a metal frame that can be mounted to motherboard 20 with compliant pins. The cage may be configured to be bezel-mounted to I/O panel 16. Cages may provide high retention force in motherboard 20 compared to other options, may allow the mounting of ports on both sides of motherboard 20, and may be intended to provide grounding for electromagnetic interference.

Fiber optic cable ports 30 may include one or more ports configured to connect motherboard 20 to a fiber-optic cable. In some embodiments, fiber optic cable ports 30 may include a cage and a port in combination to receive a transceiver. One standard transceiver is an SFP transceiver (small form-factor pluggable). SFP transceivers are designed to support SONET, Gigabit Ethernet, Fibre Channel, and other communications standards. Some other standard transceivers include SFP+ (higher data transfer rates than SFP), 10 Gigabit Small Form-Factor (XFP), Xenpak, and X2.

Twisted pair cable ports 34 may include one or more ports configured to connect a network device to a cable communicating electrical signals (e.g., telephony and/or ethernet cables). Twisted pair cable ports 34 may be disposed in a twisted pair cable connector 32 as shown in FIG. 2. In other embodiments, twisted pair cable connector 32 may include additional communication ports (e.g., firewire, USB, etc.).

Communication ports 36 may include any type of communication ports useful for providing a physical interface to PIU 14. For example, communication ports 36 may include serial communication ports and/or parallel communication ports.

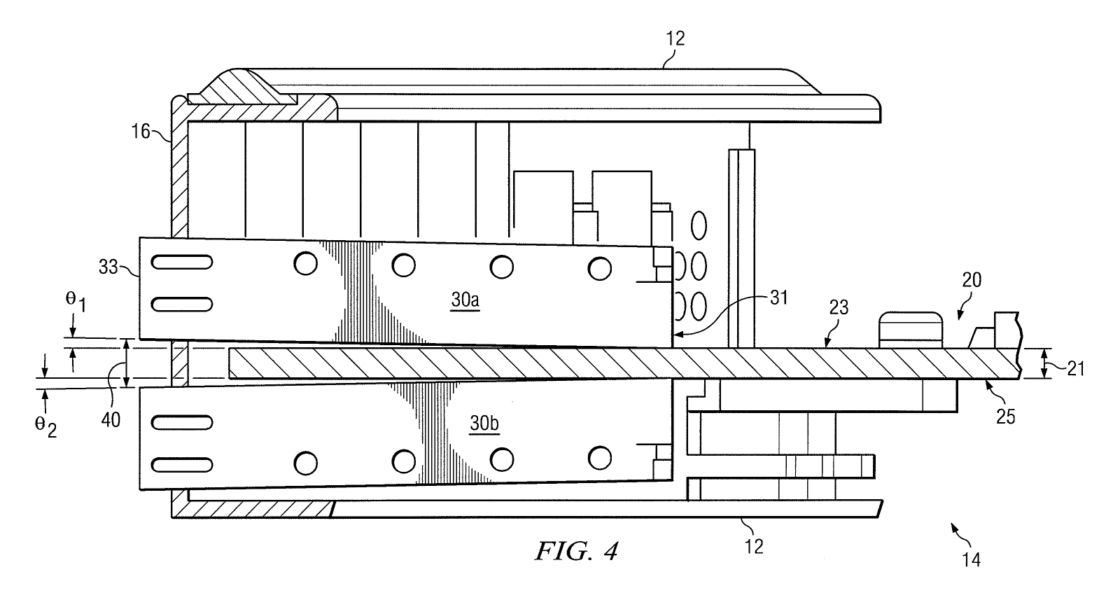

FIG. 4 illustrates a side view of plug-in unit 14. PIU 14, as shown in FIG. 1, is disposed at least partially within casing 12. While motherboard 20 is shown disposed within casing 12, other components of PIU 14 may extend outside of casing 12. For example, cages 30 may be disposed partially within casing 12 and extend through I/O panel 16 outside of casing 12. Cages 30 may include a connector end 31 disposed proximate a socket on motherboard 20 configured to connect a transceiver to the circuitry of PIU 14. Cages 30 may also include an open end proximate I/O panel 16 configured to receive the transceiver.

Motherboard 20 has a thickness 21. Motherboard 20, in some embodiments, includes a planar sheet of material with a uniform thickness 21. As discussed above, motherboard 20 may include a component side 23 and a solder side 25. As shown in FIG. 4, however, some components may be disposed on solder side 25 of motherboard 20. In such embodiments, thickness 21 may define, at least in part, the physical distance between components on opposite sides of motherboard 20.

For example, cages 30a and 30b may be separated by a distance greater than or equal to thickness 21. As shown in FIG. 4, cages 30 may be disposed on motherboard 20 at an angle, θ, to the surface of motherboard 20. For example, cage 30a may be disposed on the component side 23 of motherboard 20. Cage 30a may be disposed at an angle θ₁ to the surface of component side 23 of motherboard 20. Because of angle θ₁, the connector end 31 of cage 30a may be disposed closer to motherboard 20 than the open end 33 of cage 30a. Likewise, cage 30b may be disposed at an angle θ₂ to the surface of solder side 25 of motherboard 20.

The combination of angles θ₁ and θ₂ may result in cages 30 with open ends 33 separated by a distance 40 greater than the thickness of motherboard 20. Distance 40 may be chosen for a variety of benefits. When optical modules are inserted into respective cages 30 back-to-back, there may be physical interference between the optical modules. For example, SFP, SFP+, and XFP transceivers may interfere when stacked back-to-back. Thickness 21 of motherboard 20 may not create sufficient separation to remove the interference. In other examples, one or more latches associated with an optical module inserted in cage 30a may protrude into the opening of opposed cage 30b unless open ends 33 are separated by a sufficient distance 40.

Increasing thickness 21 of motherboard 20 may increase the cost of PIU 14, based at least in part on the additional material cost. In addition, a thicker motherboard 20 may reduce reliability of PIU 14. For example, increasing thickness 21 of motherboard 20 increases the height of any vias disposed through motherboard 20. The reliability of PIU 14 depends, at least in part, on the useful life of the vias. The reliability of the vias is reduced as their height is increased. As an example, increasing thickness 21 of motherboard 20 from 2.5 mm to 3.0 mm was estimated to increase the cost of motherboard 20 by 30% and reduce the expected life of PIU 14 under 20 years.

Alternative solutions for separating the cages require adding spacers to the motherboard, using custom cages and/or connectors configured to lift the cages off of the motherboard, and/or stacking cages. Any alternative which includes lifting the cages away from the respective surfaces of the motherboard creates multiple difficulties in manufacturing. For example, lifting the cages without lifting the associated sockets creates insertion and/or alignment problems, reducing reliability and effectiveness. As another example, lifting the cages also increases the chances that a PIU may have lamination problems and/or failures. Stacking the cages is often not an acceptable alternative because the PIU must fit within a predefined envelope so it can fit within casing 12 and/or a defined unit of rack space (e.g., 1U and/or 2U).

In contrast, disposing cages 30 at angle θ to surface 23 or 25 of motherboard 20 provides a physical separation of distance 40 without increasing the cost of PIU 14 or reducing the reliability of PIU 14 by increasing the height of any vias disposed through motherboard 20. Angle θ may be limited by the sockets and/or connectors intended to connect an optical module to the circuitry of PIU 14. For example, disposing cages 30 at an angle θ of one degree from the surfaces 23 and 25 of motherboard 20 may allow the required physical separation of distance 40 without affecting the quality of the connection between an optical module inserted in cages 30 and the circuitry of PIU 14.

In one embodiment, motherboard 20 has thickness 21 of 2.5 mm. Disposing cages 30 at angle θ generally equal to one degree provides distance 40 at open ends 33 generally equal to 4.23 mm. In this embodiment, disposing cages 30 at angle θ₁ provides significant improvement in comparison to increasing the thickness 21 of motherboard 20 to 3.5 mm. In addition to reduced material cost, increased reliability, and/or reduced manufacturing cost, this embodiment may provide up to 0.73 mm additional clearance between the open ends 33 of back-to-back cages 30.

Although the present invention has been described with several embodiments, various changes and modifications may be suggested to one skilled in the art. It is intended that the present invention encompass such changes and modifications as fall within the scope of the appended claims.

What is claimed is:

1. A system for connecting optical modules in an optical network, the system comprising:
a printed circuit board housing electronic circuitry and a plurality of electronic components, the printed circuit board having a component side and a solder side;
a first socket disposed on the component side of the printed circuit board for connecting an optical module to the electronic circuitry housed on the printed circuit board;
a first cage having a first end and a second end;
the first end of the first cage mounted to the component side of the printed circuit board proximate the first socket, wherein an optical module inserted into the second end of the first cage is retained by the first cage in electronic communication through the first socket to the electronic circuitry housed on the printed circuit board;
the first cage disposed at an angle to the surface of the printed circuit board so that the first end of the first cage is closer to the surface of the printed circuit board than the second end of the first cage;
a second socket disposed on the solder side of the printed circuit board for connecting an optical module to the electronic circuitry housed on the printed circuit board, the second socket mounted opposite the first socket; and
a second cage having a first end and a second end;
the first end of the second cage mounted to the solder side of the printed circuit board proximate the second socket, wherein an optical module inserted in the second end of the second cage is retained by the second cage in electronic communication through the first socket to the electronic circuitry;
the second cage disposed at an angle to the surface of the printed circuit board so that the first end of the second cage is closer to the surface of the printed circuit board than the second end of the second cage.

2. A system according to claim 1, wherein the optical modules include transceivers.

3. A system according to claim 1, wherein the optical modules include SFP transceivers.

4. A system according to claim 1, wherein the optical modules include SFP+transceivers.

5. A system according to claim 1, wherein the optical modules include XFP transceivers.

6. A system according to claim 1, further comprising the first cage and second cage disposed at an angle between 0 and 2 degrees to the surface of the printed circuit board.

7. A system according to claim 1, further comprising the first cage and second cage disposed at an angle of approximately 1 degree to the surface of the printed circuit board.

8. A system according to claim 1, further comprising the second end of the first cage and the second end of the second cage disposed proximate an I/O panel.

9. A system for connecting optical modules in an optical network, the system comprising:
a printed circuit board housing electronic circuitry and a plurality of electronic components, the printed circuit board having a component side and a solder side;
two cages mounted back-to-back on opposite sides of the printed circuit board, each cage having a connector end and an I/O end;
two connectors mounted back-to-back on opposite sides of the printed circuit board;
each of the two cages configured to guide an optical module into the respective connector;
each of the two cages mounted at an angle from the respective surface of the printed circuit board such that the respective I/O ends of the two cages are farther apart than the respective connector ends of the two cages.

10. A system according to claim 9, wherein the two cages are mounted to the printed circuit board by inserting a pin on the respective cage into a hole in the printed circuit board and thereby creating an interference fit.

11. A system according to claim 9, wherein the optical modules include transceivers.

12. A system according to claim 9, wherein the optical modules include SFP transceivers.

13. A system according to claim 9, wherein the optical modules include SFP+ transceivers.

14. A system according to claim 9, wherein the optical modules include XFP transceivers.

15. A system according to claim 9, wherein the angle is between 0 and 2 degrees.

16. A system according to claim 9, wherein the angle is approximately one degree.

17. A system according to claim 9, further comprising a housing including an I/O panel, wherein the optical modules may be inserted into the two cages through the I/O panel.

18. A system according to claim 9, wherein the two connectors have a maximum angle at which the optical modules may be inserted into the two connectors and wherein the angle between the two cages is set at the maximum angle.
